(19) United States
(12) Patent Application Publication
(10) Pub. No.: US 2008/0185744 A1
(43) Pub. Date: Aug. 7, 2008

(54) Thermal Conductive Curing of Ophthalmic Lenses

(75) Inventors: Larry C. Hovey, Ontario, NY (US); Charles P. Henning, Fairport, NY (US)

Correspondence Address: Bausch & Lomb Incorporated, One Bausch & Lomb Place, Rochester, NY, 14604-2701, US

(73) Assignee: BAUSCH & LOMB INCORPORATED, Rochester, NY (US)

(21) Appl. No.: 11/670,235

(22) Filed: Feb. 1, 2007

(51) Int. Cl. B29C 35/02; B29D 11/00

(52) U.S. Cl. 264/1.32; 425/143

(57) ABSTRACT

A thermal conductive system for curing ophthalmic devices within molds includes pairs of lower and upper heating units that are relatively displaceable for both clamping anterior and posterior mold parts together and conducting heat through the mold parts for curing the ophthalmic devices. The molds can be mounted in thermal engagement with the lower heating units, and the molds can be moved together with the lower heating units into thermal engagement with the upper heating units. Control systems individually regulate the temperatures of the heating units.

### BACKGROUND OF THE INVENTION

This invention relates to the production of ophthalmic devices, such as contact or intraocular lenses, by cast molding processes and, in particular, to polymerizing curing of the devices within the production process.

Within conventional cast-molding processes for producing ophthalmic lenses, such as contact or intraocular lenses, a liquid monomer or a short-chain polymer is added to molds having surfaces defined to optical specifications. Energy is supplied through the molds to cure the liquid monomer or short-chain polymer into a solid polymer having the desired optical form.

Known methods for polymerizing curing ophthalmic lenses include three common techniques: photopolymerization, convective heating, and conductive heating. Photopolymerization uses radiation to polymerize the lenses at actinic wavelengths ranging from ultraviolet (UV) to visible light. Convective heating involves heat transfers to the lenses through the medium of fluids that engulf the molds, such as by heating the molds within ovens or heated water baths. Conductive heating involves heat transfers to the lenses through solid matter, such as by directly heating the molds in which the lenses are formed.

The photopolymerization, convective heating, and conductive heating processes all have various advantages and drawbacks. Photopolymerization tends to cure the fastest, but certain compounds in tinted or UV-blocking lenses can disrupt the polymerization process. UV lamps require significant maintenance, and special care must be taken for containing the radiation. Convective heating is a well-established but somewhat inefficient process associated with the longest curing times. Conductive heating offers a more localized heating, which can provide better temperature control and shorter cure times then convective systems but has required special molds and is difficult to implement in large-scale production.

Known control systems for curing ophthalmic lenses generally include either open-loop control systems or closed-loop control systems with minimal feedback and slow response times. When curing lenses in batches, as generally required for large-scale production, the controls tend to be applied to the entire batch of lenses, which can result in initially identical lens rudiments being cured under different conditions. For example, contact lenses can be cured in batches by loading plates containing multiple mold assemblies on racks within curing ovens. The overall temperature of the curing ovens is controlled but not the temperature of the individual lenses within the ovens.

### BRIEF SUMMARY OF THE INVENTION

The invention in one or more of its preferred embodiments cures ophthalmic devices by conduction heating within a large-scale production platform that supports closed-loop control over the curing temperatures of individual ophthalmic devices. The preferred curing platform minimizes both warm-up periods and curing times while maintaining control over the heating of ophthalmic devices within the molds in which they are formed. Pairs of heating units engage anterior and posterior mold parts for imparting prescribed quantities of heat into each of the molds. Feedback systems, which monitor the performance of the heating units, maintain prescribed heating profiles for the individual devices throughout the curing process.

The engagement of the heating units with the mold parts can be controlled to regulate a clamping force applied to the molds to eliminate flash and avoid distortions of the optical surfaces defined within the mold parts. More uniformity in the curing of individual devices can be achieved in a large-scale production environment, and devices with different curing requirements can be cured within the same batch of devices to accommodate the production of different devices on demand. Batch processing can be carried out with reliable, long-lasting, but easily replaceable equipment featuring accurate feedback and fast response times for achieving precise temperature control over individual ophthalmic devices throughout the curing process.

One version of the invention as a curing station for batch processing a plurality of ophthalmic devices includes first and second sets of heating units. The first set of heating units is engageable with first parts of molds that form first optical surfaces of the ophthalmic devices. The second set of heating units is engageable with second parts of the molds that form second optical surfaces of the ophthalmic devices. The first and second sets of heating units are relatively movable into positions of engagement with the first and second mold parts for both clamping the first and second mold parts together and conducting heat through the mold parts for curing the ophthalmic devices.

The molds can be mounted in thermal engagement with the first set of heating units, and the molds can be relatively moved together with the first set of heating units into thermal engagement with the second set of heating units. Between the two sets of heating units, a clamping force can be applied to clamp the first and second parts of the molds together during the curing operation.

A first support fixture can be used for mounting the first set of heating units, a second support fixture can be used for mounting the second set of heating units, and a driver can be used for relatively moving the first and second support fixtures. A load monitor can monitor the clamping force applied to the molds between the first and second support fixtures.

Insulators can be used to thermally isolate the heating units of the first and second sets from the first and second support fixtures. Temperature monitors can be used to monitor the temperatures of the heating units, and controllers can be arranged responsive to feedback from the temperature monitors to regulate the temperatures of the heating units individually. In addition, the controllers can regulate the temperatures of the heating units according to a predetermined temperature profile for curing the ophthalmic devices. The controllers can also regulate the temperatures of heating units associated with individual molds differently from the temperatures of heating units associated with other of the molds.

Susceptors can be used for thermally adapting either or both of the first and second mold parts to the heating units. The heating units can include thermally conductive heads for transferring heat to the mold parts. Preferably, the heating units include cartridge heaters in thermal engagement with the thermally conductive heads. For example, the thermally conductive heads can be supported on posts that are mountable over the cartridge heaters. The thermally conductive heads can be replaced independently of the cartridge heaters for adapting the heating units to different shape molds.

A loader can be used to move the molds into collective alignment with the heating units of the first set of heating units. The heating units of the first and second sets can be arranged in rows, and the loader can extend between the rows for simultaneously aligning the molds between the heating units of the first and second sets. The heating units of the first set can be relatively translated into engagement with the molds, and the molds together with the heating units of the first set can be relatively translated into engagement with the heating units of the second set. A single drive can be used to move the first and second sets of heating units into engagement with opposite sides of the aligned molds.

Another version of the invention as a conductive heating assembly for batch curing ophthalmic devices in molds includes a first support fixture that supports a first set of heating units and a second support fixture that supports a second set of heating units in positions aligned with the first set of heating units. The heating units of at least the first set include a cartridge heater and a thermally conductive head that is shaped for thermally engaging the molds containing rudiments of the ophthalmic devices.

The heating units of first set can also include an insulating block for thermally isolating the heating units from the first support fixture. Similarly, the heating units of the second set can be arranged to include a cartridge heater, a thermally conductive head that is shaped for thermally engaging the molds containing the rudiments of the ophthalmic devices, and an insulating block for thermally isolating the heating units from the second support fixture.

Temperature controllers can be provided for controlling the temperatures of the first set of heating units differently from the temperatures of the second set of heating units. Feedback can be provided by temperature sensors located adjacent to the thermally conductive heads of the heating units.

The thermally conductive heads of the first set of heating units can be shaped for engaging a first part of the molds, the thermally conductive heads of the second set of heating units can be shaped for engaging a second part of the molds, and the heating units of the first and second sets can be relatively translated for clamping the first and second mold parts together between the thermally conductive heads of the first and second sets of heating units. A drive that relatively moves the first and second support fixtures together can be used for clamping the first and second mold parts together between the thermally conductive heads of the first and second sets of heating units. In addition, adjustment mechanisms can be provided for adjusting clamping forces between different molds.

The individual heating units within the first set can be paired with individual heating units of the second set, and the thermally conductive heads of the paired heating units can be aligned for engaging opposite sides of the molds. The molds, which are preferably separable into first and second parts, can be engaged by the paired heating units to clamp the first and second parts of the molds together. Susceptors can be used to thermally adapt at least one of the first and second mold parts to the thermally conductive heads of at least one of the first and second sets of heating units.

A loader can be used to align the molds collectively with the heating units of the first set of heating units. Preferably, the heating units of the first and second sets are arranged in rows, and the loader extends between the rows for simultaneously aligning the molds between the heating units of the first and second sets. A single drive can be used to both (a) relatively move the heating units of the first set into engagement with the molds and (b) relatively move the molds together with the first set of heating units into engagement with the heating units of the second set.

Another version on the invention as an intra-mold ophthalmic device curing system includes first and second sets of heating units having projections for conducting heat and a set of molds for forming ophthalmic devices. Each of the molds has first and second thermally conductive parts with mating receptors that form thermal couplings with the projections from the heating units of the first and second sets. At least one of the first and second sets of heating units is relatively moveable with respect to the set of molds for completing the thermal couplings between the projections of the first and second sets of heating units and the mating receptors of the first and second thermally conductive parts of the molds.

The first and second mold parts can be made of metal and define between them a reusable cavity for molding the ophthalmic devices. The molds can be mounted on the projections of the first set of heating units such that the projections of the first set of heating units are in thermal engagement with the mating receptors of the first parts of the molds. The molds together with the first set of heating units can be moved relative to the second set of heating units so that the projections of the second set of heating units enter into thermal engagements with the mating receptors of the second parts of the molds.

A loader can provide for aligning the molds collectively with respect to the projections of the first set of heating units. The loader is preferably relatively movable for moving the molds into positions of alignment with the projections of the first set of heating units, and the first set of heating units is preferably relatively movable with respect to the loader for mounting the molds collectively on the projections of the first heating units.

The first set of heating units is preferably carried by a first fixture, the second set of heating units is preferably carried by a second fixture, and a driver preferably provides for relatively moving the first and second fixtures for completing the thermal couplings between the projections of the first and second sets of heating units and the mating receptors of the first and second thermally conductive parts of the molds. The projections of the first and second sets of heating units are preferably aligned in pairs for clamping the first and second parts of the molds together.

Controllers can be used for regulating the temperatures of the heating units according to one or more predetermined temperature profiles for curing the ophthalmic devices. The controllers regulate the temperatures of the heating units of the first set differently from the temperatures of the heating units of the second set. In addition, the controllers can regulate the temperatures of heating units associated with individual molds differently from the temperatures of heating units associated with other of the molds. Temperature monitors can provide for monitoring the temperatures of the heating units, and the controllers can be responsive to feedback from the temperature monitors for individually regulating the temperatures of the heating units.

Yet another version of the invention as a cell for curing injection molded ophthalmic devices includes a first heating unit for engaging a first mold part for molding a first optical surface of an ophthalmic device and a second heating unit for engaging a second mold part for molding a second optical surface of the ophthalmic device. The first and second heating units are relatively aligned along a common axis. A drive relatively translates the first and second heating units along the common axis into positions of thermal engagement with the first and second mold parts.

A load monitor preferably monitors a clamping force applied between the first and second heating units against the first and second mold parts. Temperature monitors preferably monitor transfers of heat between the first and second heating units and the first and second mold parts. A controller regulates the temperatures of the first and second heating units for applying different amounts of heat from the first and second heating units to the first and second mold parts. The first and second heating units preferably include thermally conductive projections, and the first and second mold parts preferably include mating receptors for receiving the projections of the first and second heating units.

Yet another version of the invention as a method of curing ophthalmic devices within molds begins with arranging a plurality of heating units in first and second sets. A plurality of molds containing the rudiments of the ophthalmic devices is mounted on one of the sets of heating units. The second set of heating units is relatively moved with respect to the first set of heating units for clamping the molds between the first and second heating units, thereby forming thermal couplings between the molds and the first and second sets of heating units.

The clamping force applied to the molds between the first and second sets of heating units can be monitored along with the temperatures of the heating units within the first and second sets. The temperatures of individual heating units can be adjusted with respect to each other based at least in part on the monitored temperatures of the heating units. In addition, the temperatures of the heating units can be adjusted according to a temperature profile for curing the ophthalmic devices.

### BRIEF DESCRIPTION OF THE DRAWING FIGURES

FIG. 1 is a perspective view of a conductive heating assembly for curing batches of ophthalmic devices.

FIG. 2 is a cut-away cross-sectional view of a pair of heating units engaged with a two-part mold for making ophthalmic devices.

FIG. 3 is a fuller cross-sectional view of a curing cell in which the heating units are mounted on relatively movable fixtures.

FIG. 4 is a yet fuller cross-sectional view of the curing cell showing a drive for relatively moving the fixtures within a frame or housing.

FIG. 5 is cross-sectional view of an alternative curing cell for molds modified for receiving heating units.

FIG. 6 is a fuller cross-sectional view of the alternative curing cell showing a drive for relatively moving the fixtures within a frame or housing.

FIG. 7 is a perspective view of a curing station arrange for curing ophthalmic devices in batches and having an automatic loader.

### DETAILED DESCRIPTION OF THE INVENTION

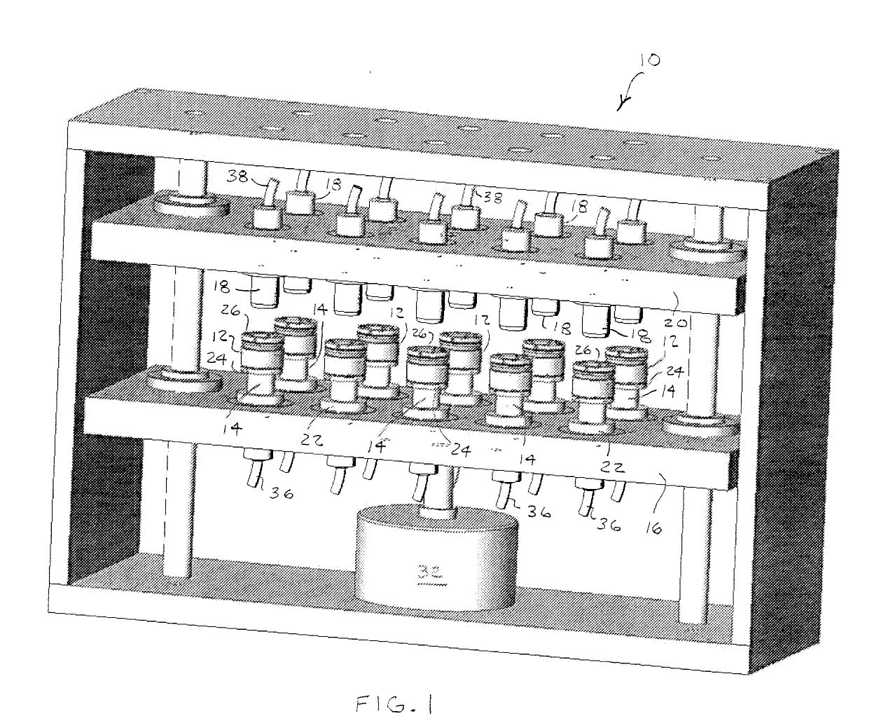

FIG. 1 depicts a conductive heating assembly 10 for curing a batch of ophthalmic devices within individual molds 12 in which the ophthalmic devices are shaped. Each of the individual molds 12 is mounted on an individual heating unit 14 within a set of lower heating units 14, all supported by a lower fixture 16 shown in the form of a plate.

A set of upper heating units 18 supported by an upper fixture 20 also shown in the form of a plate is aligned with the set of lower heating units 14. That is, each of the lower heating units 14 is paired with one of the upper heating units 18 for engaging the individual molds 12. In the illustrated heating assembly 10, the paired heating units 14 and 18 are aligned in five rows with each row containing two pairs of heating units 14 and 18. Insulators 22, which can be formed by ceramic flanges, provide intermediate mountings for thermally isolating the lower heating units 14 from the lower fixture 16. Similar insulators (not shown) can be used for thermally isolating the upper heating units from the upper fixture 20.

The individual molds 12 are fitted with lower and upper susceptors 24 and 26 that physically and thermally adapt the molds 12 for engaging the heating units 14 and 18. The lower and upper fixtures 16 and 18 are supported along common guideposts 28 within a frame or housing 30. A driver 32, such as a servomotor cylinder, translates the lower fixture 16 along the guideposts 28 to move the upper susceptors 26 of the molds 12 into engagement with the upper heating units 18. The lower susceptors 24 of the molds 12 are already mounted in engagement with the lower heating units 14, which can be carried out as a loading function. Within or at least associated with the driver 32 is a load sensor (not shown) for monitoring a clamping force applied against the individual molds 12 between the lower and upper heating units 14 and 18.

Lower and upper sets of electrical cables 36 and 38 to the lower and upper sets of heating units 14 and 18 are shown in FIG. 1 in a truncated form. The cables 36 and 38 can convey electrical power to the heating units 14 and 18 and communications to or from the heating units 14 and 18. Controllers (not shown), which are coupled to the heating units 14 and 18 through the cables 36 and 38 individually regulate the heat output from the heating units 14 and 18. Temperature sensors (not shown) such as thermocouples can be incorporated into the heating units 14 and 18 to provide temperature feedback to the controllers. Heating unit pairs 14 and 18 associated with individual molds 12 can be regulated differently from similar heating unit pairs 14 and 18 associated with other of the individual molds, and the lower and upper heating units 14 and 18 within each pair can be regulated differently for controlling intra-mold temperatures. The heat output of the heating units 14 and 18 can also be regulated differently throughout the curing process according to predetermined or otherwise desired temperature profiles.

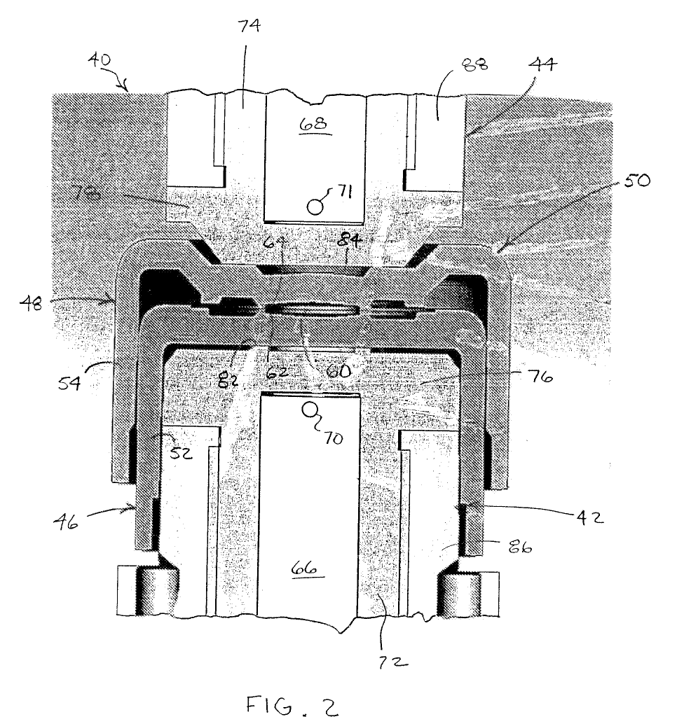

In the partial, enlarged, cross-sectional view of FIG. 2, an individual curing cell 30 includes a pair of lower and upper heating units 42 and 44 that are shown in engagement with anterior and posterior mold parts 46 and 48 of a single-use plastic mold 50. The anterior mold part 46 has an inner sleeve 52 that is guided within an outer sleeve 54 of the posterior mold part 48 for maintaining a desired alignment between the mold parts 46 and 48. A liquid monomer, a short-chain polymer, or other curable agent for molding ophthalmic devices, such as contact or intraocular lenses, is confined within a cavity 60 formed between the mold parts 46 and 48 and closed by mating shutoff rings 62 and 64.

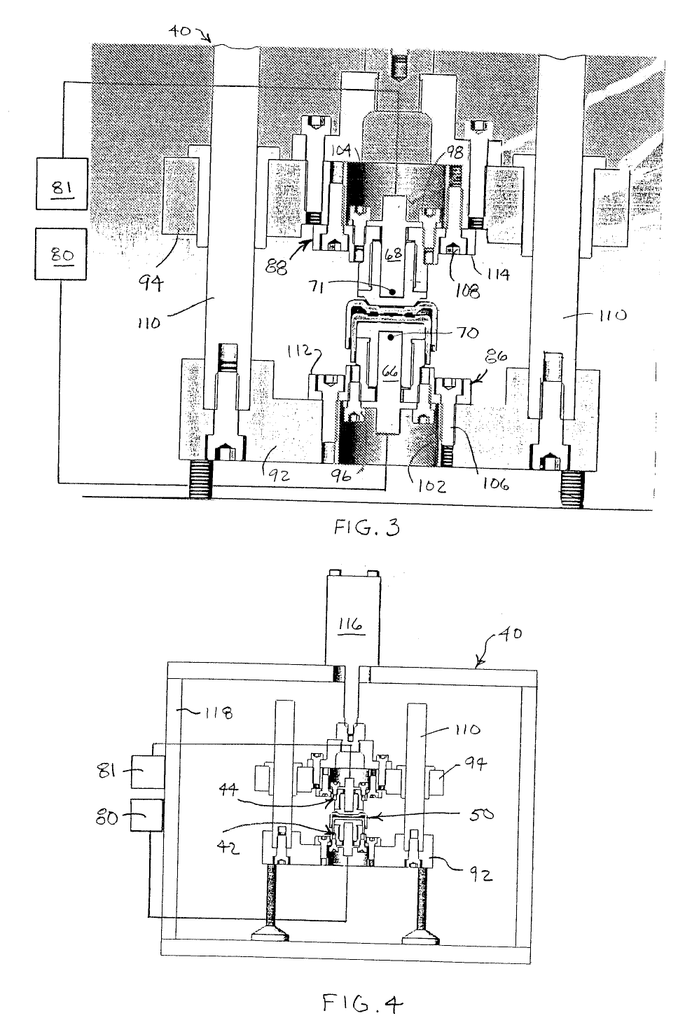

The lower and upper heating units 46 and 48 include lower and upper cartridge heaters 66 and 68, each incorporating a thermocouple 70 or 71 and operated by a controller 80 or 81 (see FIG. 3). Such cartridge heater systems are available from Watlow Electric Manufacturing Company of St. Louis, Mo. Thermally conductive lower and upper posts 72 and 74 having lower and upper heads 76 and 78 adapt the cartridge heaters 66 and 68 for engaging the anterior and posterior mold parts 46 and 48. The engagements provide for applying a clamping force between the anterior and posterior mold parts 46 and 48 and for conveying heat to the mold parts 46 and 48 from the cartridge heaters 66 and 68. An annular land 82 on the lower head 76 of the thermally conductive post 72 cooperates with a flat 84 on the upper heat 78 of the thermally conductive post 74 to direct clamping forces through the shut-off rings 62 and 64 of the anterior and posterior mold parts 46 and 48. Other features or flats can be used in combination with other mold part designs to achieve desired clamping effects (e.g., localize clamping forces, reduce flashing, and minimize mold distortion) between the heating units 42 and 44.

As more clearly seen in the fuller view of the curing cell 40 in FIG. 3, insulating flanges 86 and 88 provide for mounting the heating units 42 and 44 on relatively displaceable lower and upper fixtures 92 and 94. Bolts 96 and 98 attach the cartridge heaters 66 and 68 to the insulating flanges 86 and 88 within openings 102 and 104 within the lower and upper fixtures 92 and 94. Bolts 106 and 108 through peripheral rims 112 and 114 of the insulating flanges 86 and 88 attach the lower and upper heating units 42 and 44 to the lower and upper fixtures 92 and 94. The openings 102 and 104 through the lower and upper fixtures 92 and 94 cooperate with the insulating flanges 86 and 88 for thermally isolating the lower and upper heating units 42 and 44 and for providing conduits through the lower and upper fixtures 92 and 94 for electrically coupling the heating units 42 and 44 to their controllers 80 and 81.

The lower and upper fixtures 92 and 94 depicted in FIG. 3 support a single pair of lower and upper heating units 42 and 44, although multiple pairs of heating units could be similarly supported by enlarged fixtures for curing ophthalmic devices in batches. The lower fixture 92 is arranged as a base plate that supports guide posts 110 along which the upper fixture 94, which also has the form of a plate, is relatively translated. Within the yet fuller view of FIG. 4, a driver 116, which can take the form of a pneumatic or hydraulic cylinder, screw drive, or other displacement actuator, is mounted on a clamping frame or housing 118 for moving the upper heating unit 44 into or out of engagement with the mold 50. A pressure sensor, load cell, or other measuring device (none shown) can be used in conduction with the driver 116 to monitor the clamping pressure applied by the heating units 42 and 44 across the anterior and posterior mold parts 46 and 48. Alternatively, the lower fixture 92 could be similarly translated in place of or in addition to translating the upper fixture 94. The thermocouples 70 and 71 are preferably mounted adjacent to the upper and lower heads 76 and 78 of the thermally conductive posts 72 and 74 for monitoring temperatures or heat transfers close to the cavity 60 within which the ophthalmic devices are cured.

Although a number of paired elements, including the heating units 42 and 44 and the fixtures 92 and 94 are referenced to the drawings as being lower and upper elements, the paired elements can easily be reversed or adopt entirely different relative orientations. However, the paired elements are preferably oriented with respect to one another to support the desired clamping and heat transfer functions.

An alternative curing cell 120 especially well suited for thermally conductive multi-use molds is shown in FIG. 5. A multi-use mold 130 has cup-shaped anterior and posterior mold parts 122 and 124, which are made of coated steel or another thermally conductive material. The anterior and posterior mold parts 122 and 124 include receptors 126 and 128 that are adapted to receive lower and upper cartridge heaters 132 and 134 of lower and upper heating units 136 and 138. The cartridge heaters 132 and 134 have the form of projections that mate with the receptors 126 and 128, which have the complementary form of recesses.

The lower and upper cartridge heaters 132 and 134 are bolted to lower and upper fixtures 136 and 138 through threaded engagements with insulating flanges 142 and 144. An insulating sleeve 140 surrounds the anterior and posterior mold parts 122 and 124, joining with hubs 146 and 148 of the insulating flanges 142 and 144 for thermally isolating the anterior and posterior mold parts 122 and 124 of multi-use mold 130. The insulating flanges 142 and 144 together with openings 152 and 154 in the lower and upper fixtures 136 and 138 thermally isolate the lower and upper cartridge heaters 132 and 134 from the lower and upper fixtures 136 and 138.

The cartridge heaters 132 and 134 directly engage the receptors 126 and 128 of the anterior and posterior mold parts 122 and 124 for both clamping the anterior and posterior mold parts 122 and 124 together to form a curing cavity 150 and for conducting heat through the anterior and posterior mold parts 122 and 124 into a curing cavity 150 for curing a liquid monomer, a short-chain polymer, or other curable agents that are captured within the curing cavity 150 as the rudiments of the ophthalmic devices intended to take a more permanent form upon curing.

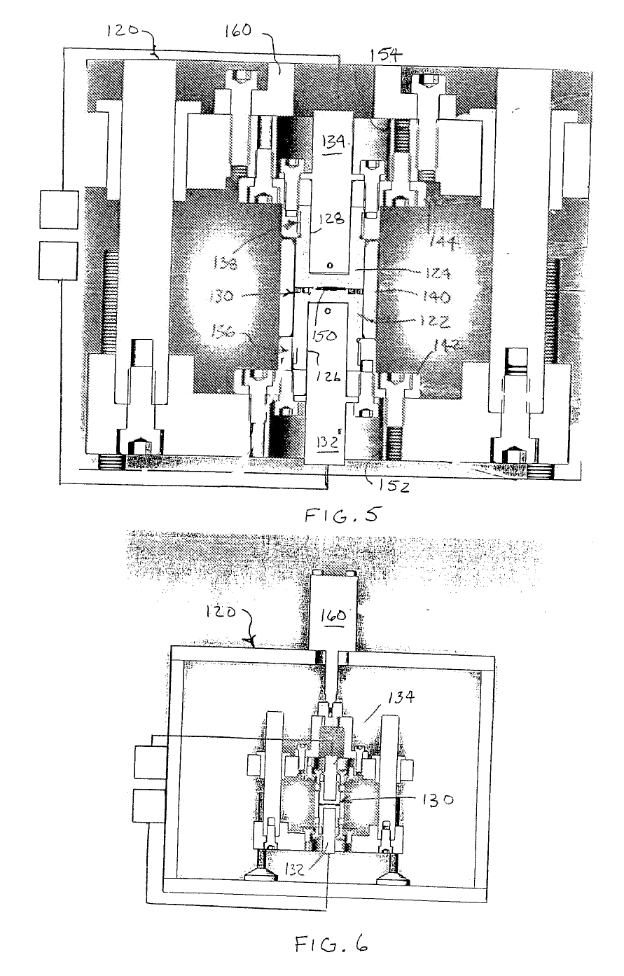

A drive 160 shown better in the fuller view of FIG. 6 can be used for relatively translating the upper fixture 138 with respect to the lower fixture 136 for moving the lower and upper cartridge heaters 132 and 134 into a clamping engagement with the receptors 126 and 128 of the anterior and posterior mold parts 122 and 124. Similar to the preceding embodiments other types of drives can be used for effecting the clamping engagements and the heating units 136 and 138 can be one pair among a plurality of pairs supported by the lower and upper fixtures for batch curing ophthalmic devices.

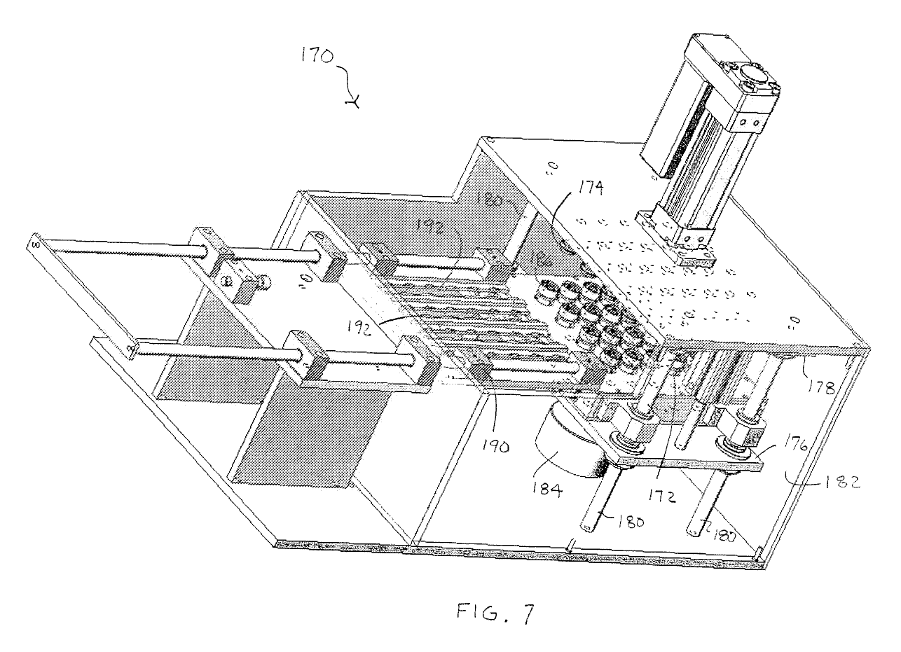

An exemplary curing station 170 is shown in FIG. 7 for batch curing ophthalmic devices as a part of an automated manufacturing process. Similar to the conductive heating assembly 10 of FIG. 1, the curing station 170 includes a plurality of lower and upper heating units 172 and 174 supported from lower and upper fixtures 176 and 178. The lower fixture 176 is translatable along guideposts 180 within a housing 182 by a driver 184. Mounted on the lower heating units 172 are molds 186 within which the rudiments of ophthalmic devices are held for curing. The molds 186 can be collectively mounted on the lower heating units 172 by an articulated loader 190. The housing 182 can be arranged to provide a controlled curing environment, such as being filled with an inert gas (e.g., nitrogen, N₂).

The paired lower and upper heating units 172 and 174 are arranged in rows and the articulated loader 190 includes rails 192 that fit between the rows for moving the molds 186 into or out of alignment with the heating units 172 and 174. The molds 186 can be moved into positions of alignment while the lower fixture 178 is lowered beneath a level of the molds 186. With the molds 186 so positioned, the lower fixture 176 can be raised for engaging the molds 186 and for lifting the engaged molds 186 off the loader 190. Thereafter, the loader 190 can be retracted from the housing 182 as shown. Further lifting of the engaged molds 186 moves the molds into engagement with the upper heating units 174 for both physically clamping the molds 186 between the lower and upper heating units 172 and 174 and thermally conducting heat from the lower and upper heating units 172 and 174 into the molds 186. Once the curing process is sufficiently complete, the loader 190 can be moved back into the housing 182 and the molds 186 can be lowered together with the lower fixture 178 out of engagement with the upper heating units 174 and onto the rails 192 of the loader. Further lowering of the lower fixture 178 withdraws the lower heating units 172 from engagement with the molds 186 and allows the molds 186 to be withdrawn from the housing 182 by retracting the loader 190.

The molds 186 can be single-use or multi-use molds made of materials that variously conduct heat from plastics to metals. The molds 186 can be modified to incorporate thermally conductive susceptors or can be formed with receptors for physically and thermally coupling the molds 186 to the lower and upper heating units 172 and 174. Cartridge heaters of the heating units 172 and 174 or thermally conductive heads in thermal communication with the cartridge heaters can be adapted (e.g., fashioned in a complementary or mating form) for completing the desired physical and thermal engagements with the molds 186. For example, the thermally conductive heads including the tool posts on which they can be supported can be fit over the cartridge heaters in a replaceable fashion to accommodate different molds.

The cartridge heaters of the heating units 172 and 174 can be individually controlled for regulating the amount of heat conducted into different molds or into different mold parts. The amount of heat conducted by the individual cartridge heaters can also be regulated over time according to desired temperature profiles (e.g., temperature as a function of time) for optimizing the curing of the ophthalmic devices. The individual controls over the cartridge heaters together with the thermal isolation of the heating units allow different ophthalmic devices having different curing requirements to be cured within the same batch. The cartridge heaters of the lower and upper heating units can also be differentially controlled to assist in the desired release of the cured ophthalmic devices from the molds.

The localized applications of heat to the mold parts can also reduce warm up times. The cartridge heaters themselves respond quickly to commands for outputting heat, and the solid-to-solid connections of the cartridge heaters to the mold parts quickly and efficiently conduct the heat outputs of the cartridge heaters to the mold parts. In addition, the cartridge heaters also preferably participate in the clamping function between the mold parts, which assures more intimate contact between solids within the solid-to-solid connections. Feedback provided by thermocouples or other temperature sensing devices along the conductive pathways allows further adjustment of the cartridge heaters to achieve desired instant local temperatures.

Although the illustrated embodiments show single drives for imparting the clamping function to one or a plurality of molds, the clamping force applied to individual molds within a group of molds can be further regulated for applying equal or different prescribed forces to the molds. The heating unit pairs can incorporate individual actuators, including piezoelectric, electromagnetic, or pressure drives, for regulating the clamping force or can incorporate springs or other compression regulating devices, such a Bellville springs, for accommodating systematic variations.

1. A curing station for batch processing a plurality of ophthalmic devices comprising
a first set of heating units engageable with first parts of molds that form first optical surfaces of ophthalmic devices,
a second set of heating units engageable with second parts of the molds that form second optical surfaces of the ophthalmic devices, and
the first and second sets of heating units being relatively movable into positions of engagement with the first and second mold parts for both clamping the first and second mold parts together and conducting heat through the mold parts for curing the ophthalmic devices.

2. The curing station of claim 1 in which the molds are mountable in thermal engagement with the first set of heating units, and the molds are relatively moveable together with the first set of heating units into thermal engagement with the second set of heating units.

3. The curing station of claim 2 in which a clamping force is applied between the first and second sets of heating units to clamp the first and second parts of the molds together during the curing operation.

4. The curing station of claim 1 further comprising a first support fixture for mounting the first set of heating units, a second support fixture for mounting the second set of heating units, and a driver for relatively moving the first and second support fixtures.

5. The curing station of claim 4 further comprising a load monitor for monitoring a clamping force applied to the molds between the first and second support fixtures.

6. The curing station of claim 4 further comprising insulators for thermally isolating the heating units of the first and second sets from the first and second support fixtures.

7. The curing station of claim 1 further comprising temperature monitors for monitoring the temperatures of the heating units and controllers responsive to feedback from the temperature monitors for individually regulating the temperatures of the heating units.

8. The curing station of claim 7 in which the controllers provide for regulating the temperatures of the heating units according to a predetermined temperature profile for curing the ophthalmic devices.

9. The curing station of claim 7 in which the controllers regulate the temperatures of heating units associated with individual molds differently from the temperatures of heating units associated with other of the molds.

10. The curing station of claim 1 further comprising susceptors for thermally adapting at least one of the first and second mold parts to the heating units of at least one of the first and second sets.

11. The curing station of claim 1 in which the heating units include thermally conductive heads for transferring heat to the mold parts.

12. The curing station of claim 11 in which the heating units include cartridge heaters in thermal engagement with the thermally conductive heads, and the thermally conductive heads are supported on posts that are mountable over the cartridge heaters.

13. The curing station of claim 11 in which the thermally conductive heads are replaceable independently of the cartridge heaters for adapting the heating units to different shape molds.

14. The curing station of claim 1 further comprising a loader for moving the molds into alignment with the heating units of the first set of heating units.

15. The curing station of claim 14 in which the heating units of the first and second sets are arranged in rows, and the loader extends between the rows for simultaneously aligning the molds between the heating units of the first and second sets.

16. The curing station of claim 15 in which a single drive relatively moves the first and second sets of heating units into engagement with opposite sides of the aligned molds.

17. A conductive heating assembly for batch curing ophthalmic devices in molds comprising
a first support fixture that supports a first set of heating units,
a second support fixture that supports a second set of heating units in positions aligned with the first set of heating units, and
each of the heating units of at least the first set of heating units including a cartridge heater and a thermally conductive head that is shaped for thermally engaging the molds containing rudiments of the ophthalmic devices.

18. The assembly of claim 17 in which the heating units of first set also include an insulating block for thermally isolating the heating units from the first support fixture.

19. The assembly of claim 18 in which the heating units of the second set also include a cartridge heater, a thermally conductive head shaped for thermally engaging the molds containing the rudiments of the ophthalmic devices, and an insulating block for thermally isolating the heating units from the second support fixture.

20. The assembly of claim 17 further comprising temperature controllers for controlling the temperatures of the first set of heating units differently from the temperatures of the second set of heating units.

21. The assembly of claim 20 in which temperature sensors located adjacent to the thermally conductive heads of the heating units.

22. The assembly of claim 17 in which each of the heating units of the second set also includes a cartridge heater and a thermally conductive head shaped for thermally engaging the molds containing the rudiments of the ophthalmic devices.

23. The assembly of claim 22 in which the thermally conductive heads of the first set of heating units are shaped for engaging a first part of the molds, the thermally conductive heads of the second set of heating units are shaped for engaging a second part of the molds, and the heating units of the first and second sets are relatively translatable for clamping the first and second mold parts together between the thermally conductive heads of the first and second sets of heating units.

24. The assembly of claim 23 further comprising a drive for relatively moving the first and second support fixtures together for clamping the first and second mold parts together between the thermally conductive heads of the first and second sets of heating units.

25. The assembly of claim 24 further comprising adjustment mechanisms for adjusting clamping forces between different molds.

26. The assembly of claim 22 in which individual heating units within the first set are paired with individual heating units of the second set, and the thermally conductive heads of the paired heating units are aligned for engaging opposite sides of the molds.

27. The assembly of claim 26 in which the molds are separable into first and second parts and the paired heating units are relatively translatable for clamping the first and second parts of the molds together.

28. The assembly of claim 27 further comprising susceptors for thermally adapting at least one of the first and second mold parts to the thermally conductive heads of at least one of the first and second sets heating units.

29. The assembly of claim 17 in which the thermally conductive heads are supported on posts within which the cartridge heaters are mounted.

30. The assembly of claim 17 in which the thermally conductive heads include facilities for replacing the thermally conductive heads independently of the cartridge heaters for adapting the heating units to different shape molds.

31. The assembly of claim 17 further comprising a loader for aligning the molds with the heating units of the first set of heating units.

32. The assembly of claim 31 in which the heating units of the first and second sets are arranged in rows and the loader extends between the rows for simultaneously aligning the molds between the heating units of the first and second sets.

33. The assembly of claim 32 in which a single drive both relatively moves the heating units of the first set into engagement with the molds and relatively moves the molds together with the first set of heating units into engagement with the heating units of the second set.

34. An intra-mold ophthalmic device curing system comprising
a first set of heating units having projections for conducting heat,
a second set of heating units having projections for conducting heat.
a set of molds for forming ophthalmic devices, each having a first and second parts with mating receptors that form thermal couplings with the projections from the heating units of the first and second sets, and
at least one of the first and second sets of heating units being relatively moveable with respect to the set of molds for completing the thermal couplings between the projections of the first and second sets of heating units and the mating receptors of the first and second parts of the molds.

35. The system of claim 34 in which the first and second mold parts are made of metal and define between them a reusable cavity for molding the ophthalmic devices.

36. The system of claim 35 in which the molds are mountable on the projections of the first set of heating units, and the projections of the first set of heating units are in thermal engagement with the mating receptors of the first parts of the molds.

37. The system of claim 36 in which the molds together with the first set of heating units are relatively movable with respect to the second set of heating units so that the projections of the second set of heating units enter into thermal engagements with the mating receptors of the second parts of the molds.

38. The system of claim 36 further comprising a loader for aligning the molds collectively with the projections of the first set of heating units.

39. The system of claim 38 in which the first set of heating units is relatively movable with respect to the loader for moving the heating units of the first set into engagement with the molds, and the molds together with the first set of heating units are relatively movable with respect to the loader for relatively moving the molds into engagement with the projections of the second heating units.

40. The system of claim 34 in which the first set of heating units is carried by a first fixture, the second set of heating units is carried by a second fixture, and a driver relatively moves the first and second fixtures for completing the thermal couplings between the projections of the first and second sets of heating units and the mating receptors of the first and second thermally conductive parts of the molds.

41. The system of claim 40 in which the projections of the first and second sets are aligned in pairs for clamping the first and second parts of the molds together.

42. The system of claim 34 further comprising controllers for regulating the temperatures of the heating units according to a predetermined temperature profile for curing the ophthalmic devices.

43. The system of claim 42 in which the controllers regulate the temperatures of the heating units of the first set differently from the temperatures of the heating units of the second set.

44. The system of claim 43 in which the controllers regulate the temperatures of heating units associated with individual molds differently from the temperatures of heating units associated with other of the molds.

45. The system of claim 42 further comprising temperature monitors for monitoring the temperatures of the heating units and the controllers are responsive to feedback from the temperature monitors for individually regulating the temperatures of the heating units.

46. A cell for curing injection molded ophthalmic devices comprising
a first heating unit for engaging a first mold part for molding a first optical surface of an ophthalmic device,
a second heating unit for engaging a second mold part for molding a second optical surface of the ophthalmic device,
the first and second heating units being relatively aligned along a common axis, and
a drive relatively translates the first and second heating units along the common axis into positions of thermal engagement with the first and second mold parts for both conducting heat to the first and second mold parts and clamping the first and second mold parts together.

47. The cell of claim 46 further comprising a load monitor monitoring a clamping force applied between the first and second heating units against the first and second mold parts.

48. The cell of claim 46 further comprising temperature monitors for monitoring transfers of heat between the first and second heating units and the first and second mold parts.

49. The cell of claim 48 further comprising a controller for regulating the temperatures of the first and second heating units for applying different amounts of heat from the first and second heating units to the first and second mold parts.

50. The cell of claim 46 in which the first and second heating units include thermally conductive projections and the first and second mold parts include mating receptors for receiving the projections of the first and second heating units.

51. A method of curing ophthalmic devices within molds comprising steps of
arranging a plurality of heating units in first and second sets,
mounting a plurality of molds containing the rudiments of ophthalmic devices on one of the sets of heating units, and
relatively moving the second set of heating units with respect to the first set of heating units for clamping the molds between the first and second heating units forming thermal couplings between the molds and the first and second sets of heating units.

52. The method of claim 51 comprising an additional step of monitoring a clamping force applied to the molds between the first and second sets of heating units.

53. The method of claim 52 comprising additional steps of monitoring temperatures of the heating units within the first and second sets and adjusting temperatures of individual heating units with respect to each other based at least in part on the monitored temperatures of the heating units.

54. The method of claim 53 in which the step of adjusting temperatures includes adjusting temperatures according to a temperature profile for curing the ophthalmic devices.
